(19) United States
(12) Patent Application Publication
(10) Pub. No.: US 2012/0232969 A1
(43) Pub. Date: Sep. 13, 2012

(54) SYSTEMS AND METHODS FOR UPDATING CLIMATE CONTROL ALGORITHMS

(75) Inventors: Anthony Michael FADELL, Portola Valley, CA (US); Yoky MATSUOKA, Palo Alto, CA (US); Matthew Lee ROGERS, Los Gatos, CA (US)

(73) Assignee: NEST LABS, INC., Palo Alto, CA (US)

(21) Appl. No.: 13/342,156

(22) Filed: Jan. 2, 2012

Related U.S. Application Data
(60) Provisional application No. 61/429,093, filed on Dec. 31, 2010.

(51) Int. Cl. G05D 23/19; G06F 15/16; G06Q 30/02

(52) U.S. Cl. 705/14.4; 709/204; 700/276

(57) ABSTRACT

A combined business and technical method is described in which a paid subscription service is offered to provide “premium” HVAC algorithms for a network-connected, multi-sensing learning thermostat. The users who have chosen to pay for the premium subscription service are provided with at least one additional feature, capability, and/or option that is not provided to unpaid “basic” subscribers of a cloud-based thermostat servicing system that is provided for all thermostat owners. According to some embodiments, an on-line interview process is administered to gather additional information for improving the settings of the thermostat. According to some embodiments, an active test is performed to determine thermal characteristics of the structure. According some embodiments, the user guaranteed to at least recoup the cost of the premium service through energy cost savings.

### CROSS-REFERENCE TO RELATED APPLICATIONS

This patent application claims the benefit of U.S. Prov. Ser. No. 61/429,093 filed Dec. 31, 2010, which is incorporated by reference herein.

### FIELD

This patent specification relates to systems, methods, and related computer program products for the monitoring and control of energy-consuming systems or other resource-consuming systems. More particularly, this patent specification relates to systems and methods for updating climate control algorithms.

### BACKGROUND

Substantial effort and attention continues toward the development of newer and more sustainable energy supplies. The conservation of energy by increased energy efficiency remains crucial to the world's energy future. According to an October 2010 report from the U.S. Department of Energy, heating and cooling account for 56% of the energy use in a typical U.S. home, making it the largest energy expense for most homes. Along with improvements in the physical plant associated with home heating and cooling (e.g., improved insulation, higher efficiency furnaces), substantial increases in energy efficiency can be achieved by better control and regulation of home heating and cooling equipment. By activating heating, ventilation, and air conditioning (HVAC) equipment for judiciously selected time intervals and carefully chosen operating levels, substantial energy can be saved while at the same time keeping the living space suitably comfortable for its occupants.

It is beneficial, at both a societal level and on a per-home basis, for a large number of homes to have their existing older thermostats replaced by newer, microprocessor controlled “intelligent” thermostats having more advanced HVAC control capabilities that can save energy while also keeping the occupants comfortable. To do this, these thermostats will need more information from the occupants as well as the environments where the thermostats are located. Preferably, these thermostats will also be capable of connection to computer networks, including both local area networks (or other “private” networks) and wide area networks such as the Internet (or other “public” networks), in order to obtain current and forecasted outside weather data, cooperate in so-called demand-response programs (e.g., automatic conformance with power alerts that may be issued by utility companies during periods of extreme weather), enable users to have remote access and/or control thereof through their network-connected device (e.g., smartphone, tablet computer, PC-based web browser), and other advanced functionalities that may require network connectivity.

It is recognized that there are a range of types of users for such intelligent thermostats. For example, some users probably do not have any desire to take advantage of new and possibly more complex settings and algorithms that may be developed, even though they may lead to increased energy savings. On the other hand, some users are keen to adopt more complex technology even if it involves increased initial interaction with the thermostat or related service. Furthermore, additional costs may be associated with developing and customizing settings and algorithms even though their use will ultimately save the user money in the long run through decreased energy costs.

It is to be appreciated that although exemplary embodiments are presented herein for the particular context of HVAC system control, there are a wide variety of other resource usage contexts for which the embodiments are readily applicable including, but not limited to, water usage, air usage, the usage of other natural resources, and the usage of other (i.e., non-HVAC-related) forms of energy, as would be apparent to the skilled artisan in view of the present disclosure. Therefore, such application of the embodiments in such other resource usage contexts is not outside the scope of the present teachings.

### SUMMARY

Provided according to one or more embodiments is a method for updating climate control settings in a network-connected thermostat. For some embodiments the method includes: offering a user of a network-connected thermostat a premium service which includes improved settings for the thermostat; and updating the thermostat with the improved settings in the event that the user accepts the offer. According to some embodiments, in the event that the user accepts the offer, online interactive customization is activated that includes administering an on-line interview to gather information for use in the improved settings. According to some embodiments, in the event that the user accepts the offer, an automatic utility rate optimizer is activated that decreases energy cost to the user by making a selection from a plurality of energy utility suppliers. According to some embodiments, the improved settings include settings to facilitate or enhance interaction between the thermostat and one or more other thermostats installed in the same structure.

For some embodiments the method for updating climate control settings in a network-connected thermostat includes: notifying the user that an active test will be performed on an enclosure; actively inducing a change, such as temperature, in the internal environment of the enclosure; measuring a response of the internal environment of the enclosure at least in part due to the induced change; and determining a thermodynamic parameter relating to the enclosure, such as thermal mass of the enclosure.

For some embodiments the method for updating climate control settings in a network-connected thermostat includes: estimating a value for cost savings associated with the a user of a network-connected thermostat adopting improved settings for the thermostat; offering the user a premium service which includes the improved settings for the thermostat; and updating the thermostat with the improved settings in the event that the user accepts the offer. According to some embodiments, the estimated value for the cost savings are displayed to the user, and according to other embodiments offer includes a guarantee that the cost of the premium service will at least be offset by energy cost savings.

Also provided according to one or more embodiments is a system adapted and configured to update climate control settings in a network-connected thermostat according to the methods described herein.

It will be appreciated that these systems and methods are novel, as are applications thereof and many of the components, systems, methods and algorithms employed and included therein. It should be appreciated that embodiments of the presently described inventive body of work can be implemented in numerous ways, including as processes, apparata, systems, devices, methods, computer readable media, computational algorithms, embedded or distributed software and/or as a combination thereof. Several illustrative embodiments are described below.

### BRIEF DESCRIPTION OF THE DRAWINGS

The inventive body of work will be readily understood by referring to the following detailed description in conjunction with the accompanying drawings, in which:

FIG. 1 is a diagram of an enclosure in which environmental conditions are controlled, according to some embodiments;

FIG. 2 is a diagram of an HVAC system, according to some embodiments;

FIGS. 3A-3B illustrate a thermostat having a user-friendly interface, according to some embodiments;

FIG. 3C illustrates a cross-sectional view of a shell portion of a frame of the thermostat of FIGS. 3A-3B;

FIG. 4 illustrates a thermostat having a head unit and a backplate (or wall dock) for ease of installation, configuration and upgrading, according to some embodiments;

FIG. 5 illustrates thermostats and computers on a private network connected to a cloud-based thermostat management system designed in accordance with some embodiments;

FIG. 6 illustrates one combination of thermostat management servers used to implement a thermostat management system in accordance with some embodiments;

FIG. 7 is a flow chart showing steps in a combined business and technical method in which users are offered a subscription service by thermostat management service, according to some embodiments;

FIG. 8 is a flow chart illustrating aspects of a graphical user interface on a network-connected, multi-sensing learning thermostat adapted to offer premium subscription services, according to some embodiments;

FIGS. 9A and 9B show aspects of a graphical user interface and an enhanced interview as part of a premium subscription service, according to some embodiments; and

FIG. 10 is a flow chart showing aspects of a real-time thermal mass determination carried out as part of a premium subscription service, according to some embodiments.

### DETAILED DESCRIPTION

The subject matter of this patent specification also relates to the subject matter of the following commonly assigned applications: U.S. Ser. No. 12/881,430 filed Sep. 14, 2010; U.S. Ser. No. 12/881,463 filed Sep. 14, 2010; U.S. Prov. Ser. No. 61/415,771 filed Nov. 19, 2010; U.S. Prov. Ser. No. 61/429,093 filed Dec. 31, 2010; U.S. Ser. No. 12/984,602 filed Jan. 4, 2011; U.S. Ser. No. 12/987,257 filed Jan. 10, 2011; U.S. Ser. No. 13/033,573 filed Feb. 23, 2011; U.S. Ser. No. 29/386,021, filed Feb. 23, 2011; U.S. Ser. No. 13/034,666 filed Feb. 24, 2011; U.S. Ser. No. 13/034,674 filed Feb. 24, 2011; U.S. Ser. No. 13/034,678 filed Feb. 24, 2011; U.S. Ser. No. 13/038,191 filed Mar. 1, 2011; U.S. Ser. No. 13/038,206 filed Mar. 1, 2011; U.S. Ser. No. 29/399,609 filed Aug. 16, 2011; U.S. Ser. No. 29/399,614 filed Aug. 16, 2011; U.S. Ser. No. 29/399,617 filed Aug. 16, 2011; U.S. Ser. No. 29/399,618 filed Aug. 16, 2011; U.S. Ser. No. 29/399,621 filed Aug. 16, 2011; U.S. Ser. No. 29/399,623 filed Aug. 16, 2011; U.S. Ser. No. 29/399,625 filed Aug. 16, 2011; U.S. Ser. No. 29/399,627 filed Aug. 16, 2011; U.S. Ser. No. 29/399,630 filed Aug. 16, 2011; U.S. Ser. No. 29/399,632 filed Aug. 16, 2011; U.S. Ser. No. 29/399,633 filed Aug. 16, 2011; U.S. Ser. No. 29/399,636 filed Aug. 16, 2011; U.S. Ser. No. 29/399,637 filed Aug. 16, 2011; U.S. Ser. No. 13/199,108, filed Aug. 17, 2011; U.S. Ser. No. 13/267,871 filed Oct. 6, 2011; U.S. Ser. No. 13/267,877 filed Oct. 6, 2011; U.S. Ser. No. 13/269,501, filed Oct. 7, 2011; U.S. Ser. No. 29/404,096 filed Oct. 14, 2011; U.S. Ser. No. 29/404,097 filed Oct. 14, 2011; U.S. Ser. No. 29/404,098 filed Oct. 14, 2011; U.S. Ser. No. 29/404,099 filed Oct. 14, 2011; U.S. Ser. No. 29/404,101 filed Oct. 14, 2011; U.S. Ser. No. 29/404,103 filed Oct. 14, 2011; U.S. Ser. No. 29/404,104 filed Oct. 14, 2011; U.S. Ser. No. 29/404,105 filed Oct. 14, 2011; U.S. Ser. No. 13/275,307 filed Oct. 17, 2011; U.S. Ser. No. 13/275,311 filed Oct. 17, 2011; U.S. Ser. No. 13/317,423 filed Oct. 17, 2011; U.S. Ser. No. 13/279,151 filed Oct. 21, 2011; U.S. Ser. No. 13/317,557 filed Oct. 21, 2011; and U.S. Prov. Ser. No. 61/627,996 filed Oct. 21, 2011. PCT/US11/61339 filed Nov. 18, 2011; PCT/US11/61344 filed Nov. 18, 2011; PCT/US11/61365 filed Nov. 18, 2011; PCT/US11/61379 filed Nov. 18, 2011; PCT/US11/61391 filed Nov. 18, 2011; PCT/US11/61479 filed Nov. 18, 2011; PCT/US11/61457 filed Nov. 18, 2011; PCT/US11/61470 filed Nov. 18, 2011; PCT/US11/61339 filed Nov. 18, 2011; PCT/US11/61491 filed Nov. 18, 2011; PCT/US11/61437 filed Nov. 18, 2011; and PCT/US11/61503 filed Nov. 18, 2011. Each of the above-referenced patent applications is incorporated by reference herein. The above-referenced patent applications are collectively referenced hereinbelow as “the commonly assigned incorporated applications.”

A detailed description of the inventive body of work is provided below. While several embodiments are described, it should be understood that the inventive body of work is not limited to any one embodiment, but instead encompasses numerous alternatives, modifications, and equivalents. In addition, while numerous specific details are set forth in the following description in order to provide a thorough understanding of the inventive body of work, some embodiments can be practiced without some or all of these details. Moreover, for the purpose of clarity, certain technical material that is known in the related art has not been described in detail in order to avoid unnecessarily obscuring the inventive body of work.

As used herein the term “HVAC” includes systems providing both heating and cooling, heating only, cooling only, as well as systems that provide other occupant comfort and/or conditioning functionality such as humidification, dehumidification and ventilation.

As used herein the terms power “harvesting,” “sharing” and “stealing” when referring to HVAC thermostats all refer to the thermostat are designed to derive power from the power transformer through the equipment load without using a direct or common wire source directly from the transformer.

As used herein the term “residential” when referring to an HVAC system means a type of HVAC system that is suitable to heat, cool and/or otherwise condition the interior of a building that is primarily used as a single family dwelling. An example of a cooling system that would be considered residential would have a cooling capacity of less than about 5 tons of refrigeration (1 ton of refrigeration=12,000 Btu/h).

As used herein the term “light commercial” when referring to an HVAC system means a type of HVAC system that is suitable to heat, cool and/or otherwise condition the interior of a building that is primarily used for commercial purposes, but is of a size and construction that a residential HVAC system is considered suitable. An example of a cooling system that would be considered residential would have a cooling capacity of less than about 5 tons of refrigeration.

As used herein the term “thermostat” means a device or system for regulating parameters such as temperature and/or humidity within at least a part of an enclosure. The term “thermostat” may include a control unit for a heating and/or cooling system or a component part of a heater or air conditioner. As used herein the term “thermostat” can also refer generally to a versatile sensing and control unit (VSCU unit) that is configured and adapted to provide sophisticated, customized, energy-saving HVAC control functionality while at the same time being visually appealing, non-intimidating, elegant to behold, and delightfully easy to use.

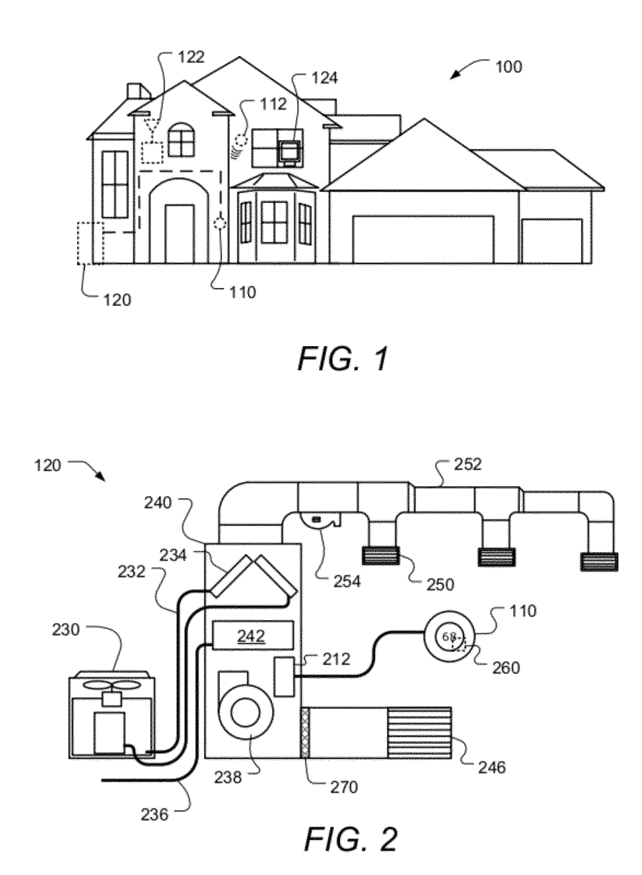

FIG. 1 is a diagram of an enclosure in which environmental conditions are controlled, according to some embodiments. Enclosure 100 is, in this example, a single-family dwelling. According to other embodiments, the enclosure can be, for example, a duplex, an apartment within an apartment building, a light commercial structure such as an office or retail store, or a structure or enclosure that is a combination of the above. Thermostat 110 controls HVAC system 120 as will be described in further detail below. According to some embodiments, the HVAC system 120 is has a cooling capacity less than about 5 tons. According to some embodiments, a remote device 112 wirelessly communicates with the thermostat 110 and can be used to display information to a user and to receive user input from the remote location of the device 112. Although many of the embodiments are described herein as being carried out by a thermostat such as thermostat 110, according to some embodiments, the same or similar techniques are employed using a remote device such as device 112.

Some embodiments of thermostat 110 in FIG. 1 incorporate one or more sensors to gather data from the environment associated with enclosure 100. Sensors incorporated in thermostat 110 may detect occupancy, temperature, light and other environmental conditions and influence the control and operation of HVAC system 120. Sensors incorporated within thermostat 110 do not protrude from the surface of the thermostat 110 thereby providing a sleek and elegant design that does not draw attention from the occupants in a house or other enclosure. As a result, thermostat 110 and readily fits with almost any décor while adding to the overall appeal of the interior design.

As used herein, a “learning” thermostat refers to a thermostat, or one of plural communicating thermostats in a multi-thermostat network, having an ability to automatically establish and/or modify at least one future setpoint in a heating and/or cooling schedule based on at least one automatically sensed event and/or at least one past or current user input. As used herein, a “primary” thermostat refers to a thermostat that is electrically connected to actuate all or part of an HVAC system, such as by virtue of electrical connection to HVAC control wires (e.g. W, G, Y, etc.) leading to the HVAC system. As used herein, an “auxiliary” thermostat refers to a thermostat that is not electrically connected to actuate an HVAC system, but that otherwise contains at least one sensor and influences or facilitates primary thermostat control of an HVAC system by virtue of data communications with the primary thermostat. In one particularly useful scenario, the thermostat 110 is a primary learning thermostat and is wall-mounted and connected to all of the HVAC control wires, while the remote thermostat 112 is an auxiliary learning thermostat positioned on a nightstand or dresser, the auxiliary learning thermostat being similar in appearance and user-interface features as the primary learning thermostat, the auxiliary learning thermostat further having similar sensing capabilities (e.g., temperature, humidity, motion, ambient light, proximity) as the primary learning thermostat, but the auxiliary learning thermostat not being connected to any of the HVAC wires. Although it is not connected to any HVAC wires, the auxiliary learning thermostat wirelessly communicates with and cooperates with the primary learning thermostat for improved control of the HVAC system, such as by providing additional temperature data at its respective location in the enclosure, providing additional occupancy information, providing an additional user interface for the user, and so forth.

It is to be appreciated that while certain embodiments are particularly advantageous where the thermostat 110 is a primary learning thermostat and the remote thermostat 112 is an auxiliary learning thermostat, the scope of the present teachings is not so limited. Thus, for example, while certain initial provisioning methods that automatically pair associate a network-connected thermostat with an online user account are particularly advantageous where the thermostat is a primary learning thermostat, the methods are more generally applicable to scenarios involving primary non-learning thermostats, auxiliary learning thermostats, auxiliary non-learning thermostats, or other types of network-connected thermostats and/or network-connected sensors. By way of further example, while certain graphical user interfaces for remote control of a thermostat may be particularly advantageous where the thermostat is a primary learning thermostat, the methods are more generally applicable to scenarios involving primary non-learning thermostats, auxiliary learning thermostats, auxiliary non-learning thermostats, or other types of network-connected thermostats and/or network-connected sensors. By way of even further example, while certain methods for cooperative, battery-conserving information polling of a thermostat by a remote cloud-based management server may be particularly advantageous where the thermostat is a primary learning thermostat, the methods are more generally applicable to scenarios involving primary non-learning thermostats, auxiliary learning thermostats, auxiliary non-learning thermostats, or other types of network-connected thermostats and/or network-connected sensors.

Enclosure 100 further includes a private network accessible both wirelessly and through wired connections and may also be referred to as a Local Area Network or LAN. Network devices on the private network include a computer 124, thermostat 110 and remote thermostat 112 in accordance with some embodiments of the present invention. In one embodiment, the private network is implemented using an integrated router 122 that provides routing, wireless access point functionality, firewall and multiple wired connection ports for connecting to various wired network devices, such as computer 124. Other embodiments may instead use multiple discrete switches, routers and other devices (not shown) to perform networking functions equivalent to or in addition to those provided by integrated router 122.

Integrated router 122 further provides network devices access to a public network, such as the Internet, provided enclosure 100 has a connection to the public network generally through a cable-modem, DSL modem and a service provider of the Internet or other public network. The Internet and other public networks are sometimes referred to as a Wide-Area Network or WAN. In one embodiment, integrated router 122 may direct communications to other devices on these networks using a network protocol such as TCP/IP. If the communications is directed to a device or service outside the private network, integrated router 122 may route the communications outside the private network to the public network such as the Internet.

In some embodiments, thermostat 110 may wirelessly communicate with remote thermostat 112 over the private network or through an ad hoc network formed directly with remote thermostat 112. During communication with remote thermostat 112, thermostat 110 may gather information remotely from the user and from the environment detectable by the remote thermostat 112. For example, remote thermostat 112 may wirelessly communicate with the thermostat 110 providing user input from the remote location of remote thermostat 112 or may be used to display information to a user, or both. Like thermostat 110, embodiments of remote thermostat 112 may also include sensors to gather data related to occupancy, temperature, light and other environmental conditions. In an alternate embodiment, remote thermostat 112 may also be located outside of the enclosure 100.

In accordance with some embodiments, a computer device 124 in enclosure 100 may remotely control thermostat 110 by accessing a thermostat management account through a thermostat management system (not shown in FIG. 1) located on a public network such as the Internet. The thermostat management system passes control information over the network back to thermostat 110 provided the thermostat 110 is also associated or paired to the thermostat management account on the thermostat management system. Data collected by thermostat 110 also passes from the private network associated with enclosure 100 through integrated router 122 and to the thermostat management system over the public network. Other computer devices not in enclosure 100 such as Smartphones, laptops and tablet computers (not shown in FIG. 1) may also control thermostat 110 provided they have access to the public network and both the thermostat management system and thermostat management account. Further details on accessing the public network, such as the Internet, and a thermostat like thermostat 110 in accordance with embodiments of the present invention is described in further detail later herein.

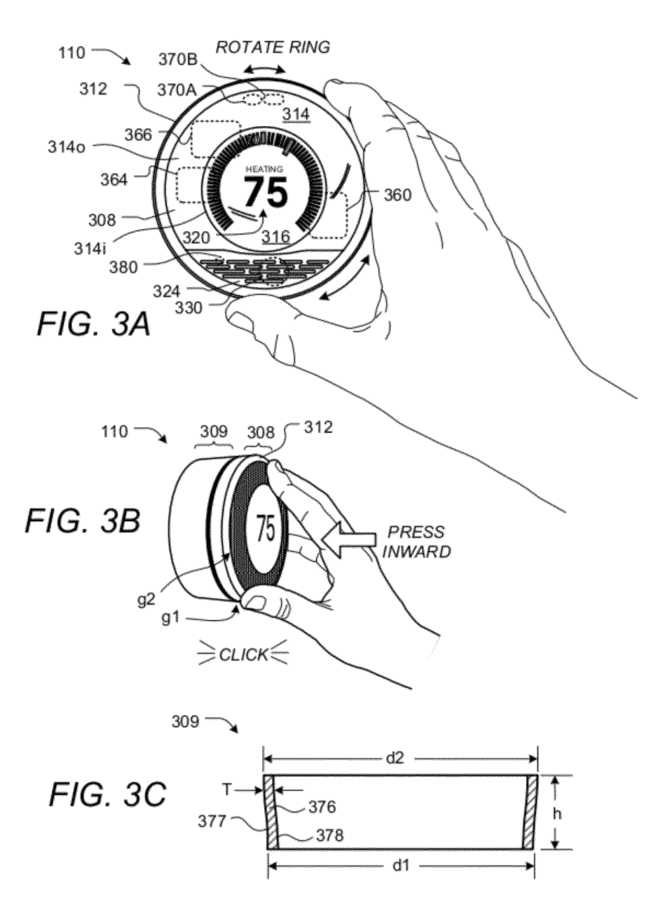

FIG. 2 is a schematic diagram of an HVAC system, according to some embodiments. HVAC system 120 provides heating, cooling, ventilation, and/or air handling for the enclosure 100, such as a single-family home depicted in FIG. 1. System 120 depicts a forced air type heating and cooling system, although according to other embodiments, other types of HVAC systems could be used such as radiant heat based systems, heat-pump based systems, and others.

In heating, heating coils or elements 242 within air handler 240 provide a source of heat using electricity or gas via line 236. Cool air is drawn from the enclosure via return air duct 246 through filter 270, using fan 238 and is heated through heating coils or elements 242. The heated air flows back into the enclosure at one or more locations via supply air duct system 252 and supply air registers such as register 250. In cooling, an outside compressor 230 passes a gas such as Freon through a set of heat exchanger coils to cool the gas. The gas then goes through line 232 to the cooling coils 234 in the air handler 240 where it expands, cools and cools the air being circulated via fan 238. A humidifier 254 may optionally be included in various embodiments that returns moisture to the air before it passes through duct system 252. Although not shown in FIG. 2, alternate embodiments of HVAC system 120 may have other functionality such as venting air to and from the outside, one or more dampers to control airflow within the duct system 252 and an emergency heating unit. Overall operation of HVAC system 120 is selectively actuated by control electronics 212 communicating with thermostat 110 over control wires 248.

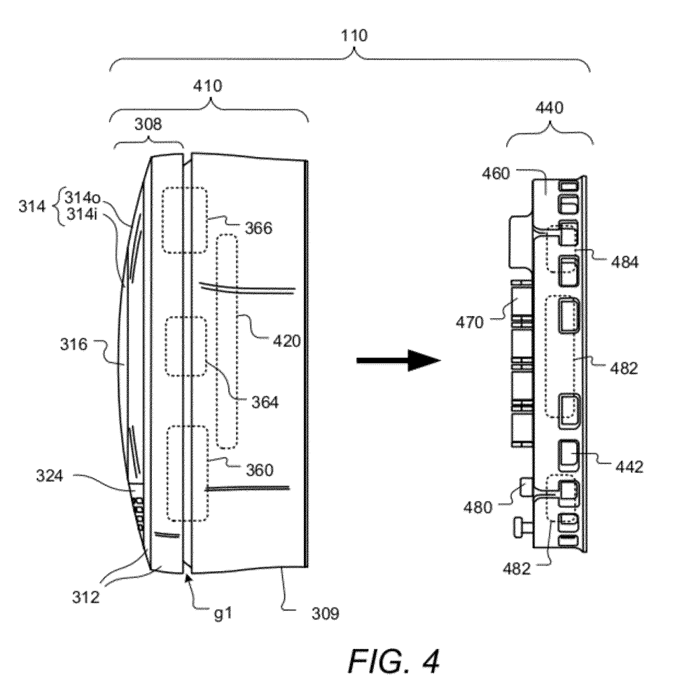

FIGS. 3A-3B illustrate a thermostat having a user-friendly interface, according to some embodiments. Unlike many prior art thermostats, thermostat 110 preferably has a sleek, simple, uncluttered and elegant design that does not detract from home decoration, and indeed can serve as a visually pleasing centerpiece for the immediate location in which it is installed. Moreover, user interaction with thermostat 110 is facilitated and greatly enhanced over known conventional thermostats by the design of thermostat 110. The thermostat 110 includes control circuitry and is electrically connected to an HVAC system, such as is shown in FIGS. 1 and 2. Thermostat 110 is wall mounted, is circular in shape, and has an outer rotatable ring 312 for receiving user input. Thermostat 110 is circular in shape in that it appears as a generally disk-like circular object when mounted on the wall. Thermostat 110 has a large front face lying inside the outer ring 312. According to some embodiments, thermostat 110 is approximately 80 mm in diameter. The outer rotatable ring 312 allows the user to make adjustments, such as selecting a new target temperature. For example, by rotating the outer ring 312 clockwise, the target temperature can be increased, and by rotating the outer ring 312 counter-clockwise, the target temperature can be decreased. The front face of the thermostat 110 comprises a clear cover 314 that according to some embodiments is polycarbonate, and a metallic portion 324 preferably having a number of slots formed therein as shown. According to some embodiments, the surface of cover 314 and metallic portion 324 form a common outward arc or spherical shape gently arcing outward, and this gentle arcing shape is continued by the outer ring 312.

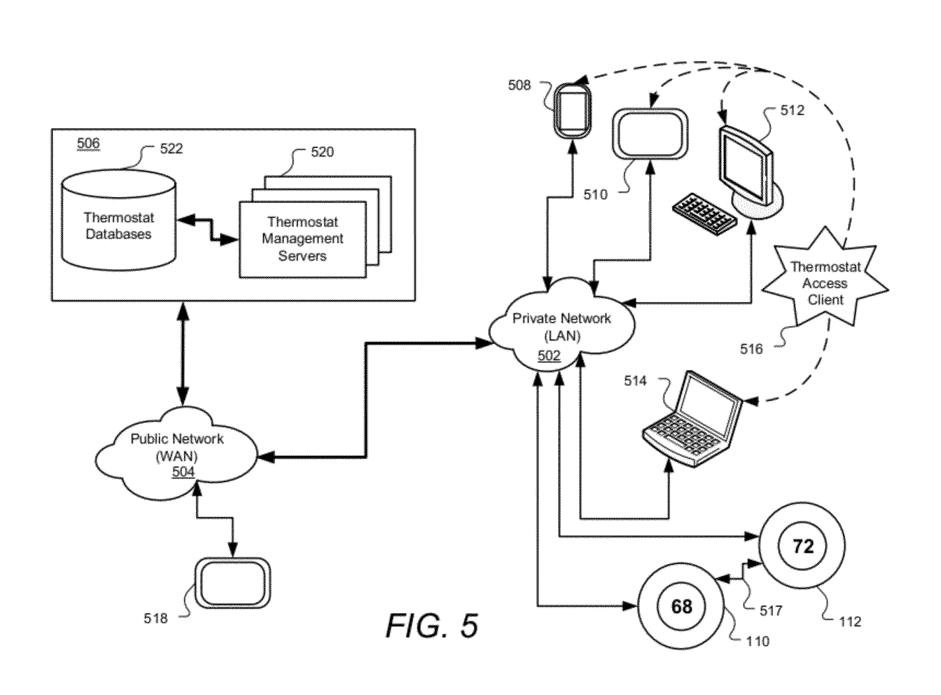

Although being formed from a single lens-like piece of material such as polycarbonate, the cover 314 has two different regions or portions including an outer portion 314o and a central portion 314i. According to some embodiments, the cover 314 is painted or smoked around the outer portion 314o, but leaves the central portion 314i visibly clear so as to facilitate viewing of an electronic display 316 disposed thereunderneath. According to some embodiments, the curved cover 314 acts as a lens that tends to magnify the information being displayed in electronic display 316 to users. According to some embodiments the central electronic display 316 is a dot-matrix layout (individually addressable) such that arbitrary shapes can be generated, rather than being a segmented layout. According to some embodiments, a combination of dot-matrix layout and segmented layout is employed. According to some embodiments, central display 316 is a backlit color liquid crystal display (LCD). An example of information displayed on the electronic display 316 is illustrated in FIG. 3A, and includes central numerals 320 that are representative of a current setpoint temperature. According to some embodiments, metallic portion 324 has number of slot-like openings so as to facilitate the use of a passive infrared motion sensor 330 mounted therebeneath. The metallic portion 324 can alternatively be termed a metallic front grille portion. Further description of the metallic portion/front grille portion is provided in the commonly assigned U.S. No. 13/199,108, supra. The thermostat 110 is preferably constructed such that the electronic display 316 is at a fixed orientation and does not rotate with the outer ring 312, so that the electronic display 316 remains easily read by the user. For some embodiments, the cover 314 and metallic portion 324 also remain at a fixed orientation and do not rotate with the outer ring 312. According to one embodiment in which the diameter of the thermostat 110 is about 80 mm, the diameter of the electronic display 316 is about 45 mm. According to some embodiments an LED indicator 380 is positioned beneath portion 324 to act as a low-power-consuming indicator of certain status conditions. For, example the LED indicator 380 can be used to display blinking red when a rechargeable battery of the thermostat (see FIG. 4A, infra) is very low and is being recharged. More generally, the LED indicator 380 can be used for communicating one or more status codes or error codes by virtue of red color, green color, various combinations of red and green, various different blinking rates, and so forth, which can be useful for troubleshooting purposes.

Motion sensing as well as other techniques can be use used in the detection and/or predict of occupancy, as is described further in the commonly assigned U.S. Ser. No. 12/881,430, supra. According to some embodiments, occupancy information is used in generating an effective and efficient scheduled program. Preferably, an active proximity sensor 370A is provided to detect an approaching user by infrared light reflection, and an ambient light sensor 370B is provided to sense visible light. The proximity sensor 370A can be used to detect proximity in the range of about one meter so that the thermostat 110 can initiate “waking up” when the user is approaching the thermostat and prior to the user touching the thermostat. Such use of proximity sensing is useful for enhancing the user experience by being “ready” for interaction as soon as, or very soon after the user is ready to interact with the thermostat. Further, the wake-up-on-proximity functionality also allows for energy savings within the thermostat by “sleeping” when no user interaction is taking place our about to take place. The ambient light sensor 370B can be used for a variety of intelligence-gathering purposes, such as for facilitating confirmation of occupancy when sharp rising or falling edges are detected (because it is likely that there are occupants who are turning the lights on and off), and such as for detecting long term (e.g., 24-hour) patterns of ambient light intensity for confirming and/or automatically establishing the time of day.

According to some embodiments, for the combined purposes of inspiring user confidence and further promoting visual and functional elegance, the thermostat 110 is controlled by only two types of user input, the first being a rotation of the outer ring 312 as shown in FIG. 3A (referenced hereafter as a “rotate ring” or “ring rotation” input), and the second being an inward push on an outer cap 308 (see FIG. 3B) until an audible and/or tactile “click” occurs (referenced hereafter as an “inward click” or simply “click” input). For the embodiment of FIGS. 3A-3B, the outer cap 308 is an assembly that includes all of the outer ring 312, cover 314, electronic display 316, and metallic portion 324. When pressed inwardly by the user, the outer cap 308 travels inwardly by a small amount, such as 0.5 mm, against an interior metallic dome switch (not shown), and then springably travels back outwardly by that same amount when the inward pressure is released, providing a satisfying tactile “click” sensation to the user's hand, along with a corresponding gentle audible clicking sound. Thus, for the embodiment of FIGS. 3A-3B, an inward click can be achieved by direct pressing on the outer ring 312 itself, or by indirect pressing of the outer ring by virtue of providing inward pressure on the cover 314, metallic portion 314, or by various combinations thereof. For other embodiments, the thermostat 110 can be mechanically configured such that only the outer ring 312 travels inwardly for the inward click input, while the cover 314 and metallic portion 324 remain motionless. It is to be appreciated that a variety of different selections and combinations of the particular mechanical elements that will travel inwardly to achieve the “inward click” input are within the scope of the present teachings, whether it be the outer ring 312 itself, some part of the cover 314, or some combination thereof. However, it has been found particularly advantageous to provide the user with an ability to quickly go back and forth between registering “ring rotations” and “inward clicks” with a single hand and with minimal amount of time and effort involved, and so the ability to provide an inward click directly by pressing the outer ring 312 has been found particularly advantageous, since the user's fingers do not need to be lifted out of contact with the device, or slid along its surface, in order to go between ring rotations and inward clicks. Moreover, by virtue of the strategic placement of the electronic display 316 centrally inside the rotatable ring 312, a further advantage is provided in that the user can naturally focus their attention on the electronic display throughout the input process, right in the middle of where their hand is performing its functions. The combination of intuitive outer ring rotation, especially as applied to (but not limited to) the changing of a thermostat's setpoint temperature, conveniently folded together with the satisfying physical sensation of inward clicking, together with accommodating natural focus on the electronic display in the central midst of their fingers' activity, adds significantly to an intuitive, seamless, and downright fun user experience. Further descriptions of advantageous mechanical user-interfaces and related designs, which are employed according to some embodiments, can be found in U.S. Ser. No. 13/033,573, supra, U.S. Ser. No. 29/386,021, supra, and U.S. Ser. No. 13/199,108, supra.

FIG. 3C illustrates a cross-sectional view of a shell portion 309 of a frame of the thermostat of FIGS. 3A-B, which has been found to provide a particularly pleasing and adaptable visual appearance of the overall thermostat 110 when viewed against a variety of different wall colors and wall textures in a variety of different home environments and home settings. While the thermostat itself will functionally adapt to the user's schedule as described herein and in one or more of the commonly assigned incorporated applications, supra, the outer shell portion 309 is specially configured to convey a “chameleon” quality or characteristic such that the overall device appears to naturally blend in, in a visual and decorative sense, with many of the most common wall colors and wall textures found in home and business environments, at least in part because it will appear to assume the surrounding colors and even textures when viewed from many different angles. The shell portion 309 has the shape of a frustum that is gently curved when viewed in cross-section, and comprises a sidewall 376 that is made of a clear solid material, such as polycarbonate plastic. The sidewall 376 is backpainted with a substantially flat silver- or nickel- colored paint, the paint being applied to an inside surface 378 of the sidewall 376 but not to an outside surface 377 thereof. The outside surface 377 is smooth and glossy but is not painted. The sidewall 376 can have a thickness T of about 1.5 mm, a diameter d1 of about 78.8 mm at a first end that is nearer to the wall when mounted, and a diameter d2 of about 81.2 mm at a second end that is farther from the wall when mounted, the diameter change taking place across an outward width dimension “h” of about 22.5 mm, the diameter change taking place in either a linear fashion or, more preferably, a slightly nonlinear fashion with increasing outward distance to form a slightly curved shape when viewed in profile, as shown in FIG. 3C. The outer ring 312 of outer cap 308 is preferably constructed to match the diameter d2 where disposed near the second end of the shell portion 309 across a modestly sized gap g1 therefrom, and then to gently arc back inwardly to meet the cover 314 across a small gap g2. It is to be appreciated, of course, that FIG. 3C only illustrates the outer shell portion 309 of the thermostat 110, and that there are many electronic components internal thereto that are omitted from FIG. 3C for clarity of presentation, such electronic components being described further hereinbelow and/or in other ones of the commonly assigned incorporated applications, such as U.S. Ser. No. 13/199,108, supra.

According to some embodiments, the thermostat 110 includes a processing system 360, display driver 364 and a wireless communications system 366. The processing system 360 is adapted to cause the display driver 364 and display area 316 to display information to the user, and to receiver user input via the rotatable ring 312. The processing system 360, according to some embodiments, is capable of carrying out the governance of the operation of thermostat 110 including the user interface features described herein. The processing system 360 is further programmed and configured to carry out other operations as described further hereinbelow and/or in other ones of the commonly assigned incorporated applications. For example, processing system 360 is further programmed and configured to maintain and update a thermodynamic model for the enclosure in which the HVAC system is installed, such as described in U.S. Ser. No. 12/881,463, supra, and in International Patent App. No. PCT/US11/51579, incorporated herein by reference. According to some embodiments, the wireless communications system 366 is used to communicate with devices such as personal computers and/or other thermostats or HVAC system components, which can be peer-to-peer communications, communications through one or more servers located on a private network, or and/or communications through a cloud-based service.

FIG. 4 illustrates a side view of the thermostat 110 including a head unit 410 and a backplate (or wall dock) 440 thereof for ease of installation, configuration and upgrading, according to some embodiments. As is described hereinabove, thermostat 110 is wall mounted and has circular in shape and has an outer rotatable ring 312 for receiving user input. Head unit 410 includes the outer cap 308 that includes the cover 314 and electronic display 316. Head unit 410 of round thermostat 110 is slidably mountable onto back plate 440 and slidably detachable therefrom. According to some embodiments the connection of the head unit 410 to backplate 440 can be accomplished using magnets, bayonet, latches and catches, tabs or ribs with matching indentations, or simply friction on mating portions of the head unit 410 and backplate 440. According to some embodiments, the head unit 410 includes a processing system 360, display driver 364 and a wireless communications system 366. Also shown is a rechargeable battery 420 that is recharged using recharging circuitry 422 that uses power from backplate that is either obtained via power harvesting (also referred to as power stealing and/or power sharing) from the HVAC system control circuit(s) or from a common wire, if available, as described in further detail in co-pending patent application U.S. Serial Nos. 13/034,674, and 13/034,678, which are incorporated by reference herein. According to some embodiments, rechargeable battery 420 is a single cell lithium-ion, or a lithium-polymer battery.

Backplate 440 includes electronics 482 and a temperature/humidity sensor 484 in housing 460, which are ventilated via vents 442. Two or more temperature sensors (not shown) are also located in the head unit 410 and cooperate to acquire reliable and accurate room temperature data. Wire connectors 470 are provided to allow for connection to HVAC system wires. Connection terminal 480 provides electrical connections between the head unit 410 and backplate 440. Backplate electronics 482 also includes power sharing circuitry for sensing and harvesting power available power from the HVAC system circuitry.

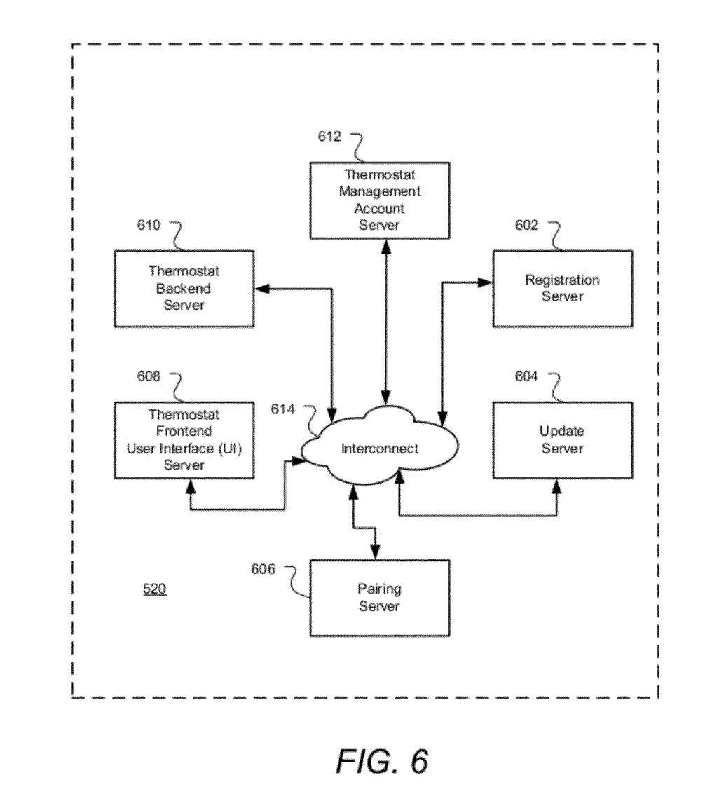

FIG. 5 illustrates thermostats and computers on a private network 502 connected to a cloud-based thermostat management system 506 designed in accordance with some embodiments. In one embodiment, private network 502 is designed to provide network connectivity primarily within and near an enclosure, such as enclosure 100 in FIG. 1. Private network 502 additionally provides network connectivity for various devices such a smartphone 508, tablet 510, computer 512, and laptop 514, as well as the thermostat 110 and remote thermostat 112. A router (not shown) in private network 502, such as integrated router 122 in FIG. 1, may provide wired and wireless connectivity for these devices using a network protocol such as TCP/IP. Preferably, thermostat 110 and remote thermostat 112 are connected wirelessly to private network 502, for at least the reason that wired connections to the locations of the thermostats may not available, or it may be undesirable to incorporate such physical connections in either thermostat 110 or remote thermostat 112. For some embodiments, it is also possible for thermostat 110 and remote thermostat 112 to communicate directly with each other and other devices wireless using an ad hoc network 517 preferably setup directly between the devices and bypassing private network 502.

The embodiments described herein are advantageously configured to be compatible with a large variety of conventional integrated routers that service a large population of homes and businesses. Thus, by way of example only and not by way of limitation, the router (not shown) that services the private network 502 of FIG. 5 can be, for example, a D-Link DIR-655 Extreme N Wireless Router, a Netgear WNDR3700 RangeMax Dual Band Wireless USB Gigabit Router, a Buffalo Technology Nfiniti WZR-HP-G300NH Wireless-N Router, an Asus RT-N16 Wireless Router, Cisco Linksys E4200 Dual Band Wireless Router, or a Cisco Linksys E4200 Dual Band Wireless Router. Without loss of generality, some descriptions further hereinbelow will refer to an exemplary scenario in which the thermostats 110/112 are used in a home environment. However, it is to be appreciated that the described embodiments are not so limited, and are applicable to use of such thermostat(s) in any of a variety of enclosures including residential homes, business, vacation homes, hotels, hotel rooms, industrial facilities, and generally anywhere there is an HVAC system to be controlled.

Thermostat access client 516 is a client application designed in accordance with aspects of the present invention to access the thermostat management system 506 over public network 504. The term “thermostat management system” can be interchangeably referenced as a “cloud-based management server” for the thermostats, or more simply “cloud server”, in various descriptions hereinabove and hereinbelow. Because thermostat access client 516 is designed to execute on different devices, multiple client applications may be developed using different technologies based on the requirements of the underlying device platform or operating system. For some embodiments, thermostat access client 516 is implemented such that end users operate their Internet-accessible devices (e.g., desktop computers, notebook computers, Internet-enabled mobile devices, cellphones having rendering engines, or the like) that are capable of accessing and interacting with the thermostat management system 506. The end user machine or device has a web browser (e.g., Internet Explorer, Firefox, Chrome, Safari) or other rendering engine that, typically, is compatible with AJAX technologies (e.g., XHTML, XML, CSS, DOM, JSON, and the like). AJAX technologies include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (Javascript Object Notation, a lightweight data interchange format) as a format to transfer data between the server and the client. In a web environment, an end user accesses the site in the usual manner, i.e., by opening the browser to a URL associated with a service provider domain. The user may authenticate to the site (or some portion thereof) by entry of a username and password. The connection between the end user entity machine and the system may be private (e.g., via SSL). The server side of the system may comprise conventional hosting components, such as IP switches, web servers, application servers, administration servers, databases, and the like. Where AJAX is used on the client side, client side code (an AJAX shim) executes natively in the end user's web browser or other rendering engine. Typically, this code is served to the client machine when the end user accesses the site, although in the alternative it may be resident on the client machine persistently. Finally, while a web-based application over Internet Protocol (IP) is described, this is not a limitation, as the techniques and exposed user interface technologies may be provided by a standalone application in any runtime application, whether fixed line or mobile. It is to be appreciated that although the TCP/IP protocol is set forth as the network protocol used for communications among the thermostat management system 506, the thermostat access client 514, and other devices for some embodiments, it is set forth by way of example and not by way of limitation, with the use of any other suitable protocol, such as UDP over IP in particular, may be used without departing from the scope of the present teachings.

In yet another embodiment, thermostat access client 516 may be a stand-alone application or “app” designed to be downloaded and run on a specific device such as smartphone 508 or a tablet 510 device running the Apple iOS operating system, Android operating system, or others. Developers create these stand-alone applications using a set of application programming interfaces (APIs) and libraries provided by the device manufacturer packaged in software development toolkit or SDK. Once completed, the “app” is made available for download to the respective device through an application store or “app” store curated by the app store owners to promote quality, usability and customer satisfaction.

In one embodiment, thermostat management system 506 illustrated in FIG. 5 may be accessed over public network 504 by computer devices on private network 502 running thermostat access client 516. Thermostat access client 516 accesses a thermostat management account (not illustrated) provisioned by thermostat management system 506, on behalf of the computer devices, in order to access or control thermostat 110 or remote thermostat 112. In addition, a computer device on private network 502 such as computer 512 may use the thermostat access client 516 and thermostat management account on to gather data from thermostat 110 and remote thermostat 112.

Thermostat 110 and remote thermostat 112 may be accessed remotely from numerous different locations on the private network 502 or public network 504. As will be described in further detail hereinbelow, upon installation a thermostat such as thermostat 110 first registers with the thermostat management system 506 and then requests the thermostat management system create a pairing between the thermostat and a corresponding thermostat management account. Thereafter, a device such as a tablet 518 may be connected to public network 504 directly or through a series of other private networks (not shown) yet still access these thermostats, while outside the private network where they are located, by way of thermostat management system 506. In one embodiment, a tablet 518 running the Apple iOS operating system may remotely access to these thermostats through the thermostat management system 506 and thermostat management account using an iOS “app” version of thermostat access client 516. Pairing thermostats with the thermostat management account allows tablet 518 and other computer devices to remotely control, gather data, and generally interact with thermostats such as thermostat 110 and remote thermostat 112.

In one embodiment, thermostat management system 506 distributes the task of communication and control with the thermostats to one or more thermostat management servers 520. These thermostat management servers 520 may coordinate communication, manage access, process data and analyze results using data produced by thermostats such as thermostat 110 and remote thermostat 112. Intermediate and final results from computations on these servers 520, as well as raw data, may be stored temporarily or archived on thermostat databases 522 for future reference and use. Thermostat management servers 520 may also send a portion of the data along with control information, and more generally any of a variety of different kinds of information, back to thermostat 110 and remote thermostat 112. Results from the thermostat management servers 520 may also be stored in one or more thermostat databases 522 for subsequent access by a device such as tablet 518 running thermostat access client 516.

These thermostat management servers 520 each may perform one or several discrete functions, may serve as redundant fail-over servers for these different discrete functions or may share performance of certain discrete functions in tandem or in a cluster as well as other combinations performing more complex operations in parallel or distributed over one or more clusters of computers. In some embodiments, one of the thermostat management servers 520 may correspond directly to a physical computer or computing device while in other embodiments, the thermostat management servers 520 may be virtualized servers running on one or more physical computers under the control of a virtual machine computing environment such as provided by VMWARE of Palo Alto, Calif. or any other virtual machine provider. In yet another embodiment, the thermostat management servers 520 and thermostat databases 522 are provisioned from a “cloud” computing and storage environment such as the Elastic Compute Cloud or EC2 offering from Amazon.com of Seattle, Wash. In an EC2 solution, for example, the thermostat management servers 520 may be allocated according to processor cycles and storage requirements rather than according to a number of computers, either real or virtual, thought to be required for the task at hand.

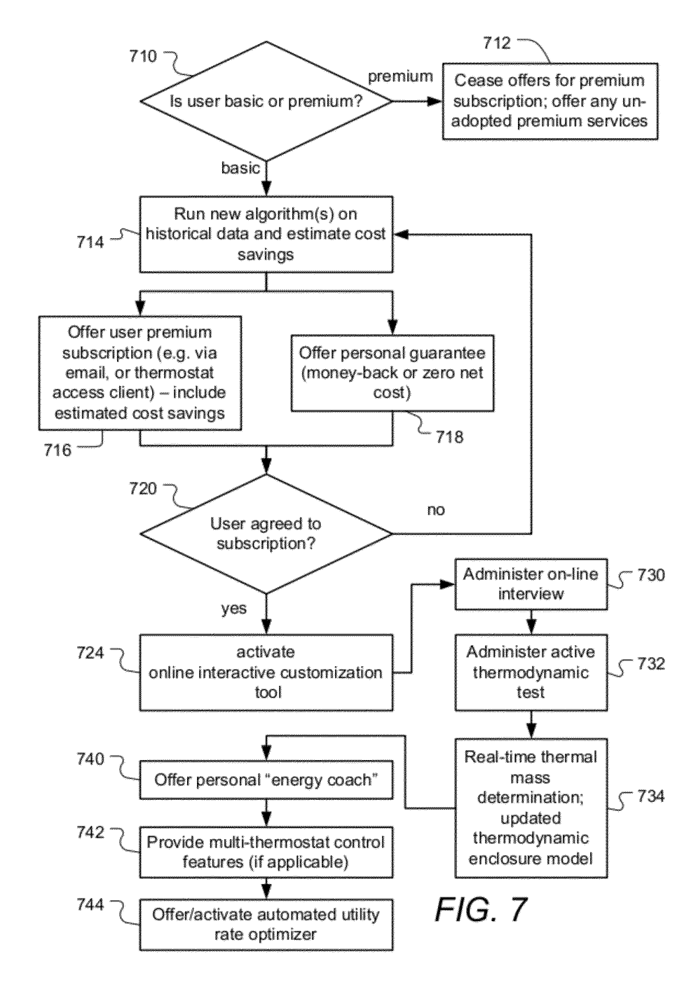

FIG. 6 illustrates one combination of thermostat management servers 520 used to implement a thermostat management system 506 in accordance with some embodiments. In one embodiment, the thermostat management system 506 includes a registration server 602, an update server 604, a pairing server 606, a thermostat frontend user interface (UI) server 608, a thermostat backend server 610, and a thermostat management account server 612. Interconnect 614 may connect servers using one or more high-speed network connections, a shared back plane, a combination of local and remote high-speed connections as well as one or more virtualized connections. While the configuration of thermostat management servers 520 is exemplary, it is should not be considered limiting in any way and it is contemplated that the distribution of functions may be handled through a different combination of servers and distribution of function over those servers.

In some embodiments, the thermostat management servers 520 making up this thermostat management system 506 may manage thermostats located in multiple enclosures across various geographic locations and time zones. Each enclosure may use one or several thermostats in accordance with embodiments of the present invention to control one or several HVAC systems, such as HVAC system 120 in FIG. 1. In some cases, there may be an increased need from the thermostat management system 506 for certain functions and therefore more servers to deliver these functional capabilities. It may be appreciated that the design of thermostat management system 506 and use of the thermostat management servers 520 may be scaled to meet these demands on the system and efficiently track and organize the data from these multiple enclosures and thermostats for processing, analysis, control and machine-learning purposes.

One embodiment of registration server 602 provides a number of services related to registering a thermostat on the thermostat management system 506 and preparing it for pairing with a thermostat management account. In operation, the registration server 602 may be first accessed by a thermostat when the thermostat is wired to the HVAC of an enclosure and then connected to the Internet through a private network. To make the thermostat known on system 520, the thermostat sends thermostat metadata from the private network to the public network, such as the Internet, and then onto processing by registration server 602. Preferably, the thermostat metadata includes a unique thermostat identifier, such as one that is assigned at the time of manufacturing. As the communication that sends the thermostat metadata passes through the network address translator (NAT) of the router (not shown) that serves private network 502, it is appended with the public network address of that router, which is thus the public address that is “used” by the thermostat to communicate over the public network. The thermostat identifier is used to identify the thermostat from other thermostats being registered by registration server 602 and may be based, in part or in whole, on a media access control (MAC) address assigned to the NIC of the thermostat. As one security measure against registering unauthorized devices, registration server 602 may compare the MAC address in the thermostat metadata against a list of valid MAC addresses provided by the manufacturer of the thermostat or NIC component. In accordance with one embodiment, the thermostat registration is complete when the registration server 602 provisions an entry in a thermostat registration pool and marks the thermostat entry ready to be paired with a thermostat management account. Entries in the thermostat registration pool may be referenced by their unique thermostat identifier, the public network address that they used (or, more particularly, the public address of the private network router through which they connect to the Internet), and optionally other relevant metadata associated with the thermostat.

In some embodiments, update server 604 attempts to update software, firmware and configuration updates to each of the thermostats registered in the thermostat registration pool. If metadata from entries in the registration pool exclude versioning information, update server may need to further query each thermostat for current versions installed. Update server 604 may access entries in the registration pool and then use corresponding network addresses in each entry to connect to the associated thermostat over the public network or private network, or both.

If newer software versions exist than currently used on a thermostat, update server 604 proceeds to send software updates to the thermostat over the public network. For example, update server may use file transfer protocols such as ftp (file transfer protocol), tftp (trivial file transfer protocol) or more secure transfer protocols when uploading the new software. Once uploaded, installation and update of the software on the thermostat may occur immediately through an auto-update option on the thermostat or manually through the interface of the thermostat as requested by a user.

One embodiment of pairing server 606 facilitates the association or “pairing” of a thermostat with a thermostat management account on thermostat management account server 612. The term “thermostat management account” can be used interchangeably with “user account” herein unless specified otherwise. Once the thermostat is paired with a user account, a rich variety of network-enabled capabilities are enabled as described further herein and in one or more of the commonly assigned incorporated applications, supra. For example, once pairing has been achieved, a person with access to the thermostat management account may access the thermostat (through the thermostat management system 506 using the thermostat access client 516) for a variety of purposes such as seeing the current temperature of the home, changing the current setpoint, changing the mode of the thermostat between “home” and “away”, and so forth. Moreover, the thermostat management system 506 can then start tracking the various information provided by the thermostat which, in turn, enables a rich variety of cloud-based data aggregation and analysis that can be used to provide relevant reports, summaries, updates, and recommendations to the user either through the thermostat display itself, through the thermostat access client 516, or both. A variety of other capabilities, such as demand-response actions in which the thermostat management server sends an energy alert and/or sends energy-saving setpoint commands to the thermostats of users who have enrolled in such programs, can be carried out.

In view of the importance of establishing a pairing between the thermostat and a thermostat management account, there is provided an ability for a fallback method of pairing, which can be termed a “manually assisted” method of pairing, that can take effect and be carried out in the event that the convenient auto-pairing methods described further hereinbelow cannot be securely and reliably carried out for a particular installation. The manually assisted method may use an alphanumeric “passcode” to pair the thermostat to the thermostat management account. Typically, the passcode is sent to the thermostat over a public network, like the Internet, and displayed on the display area of the thermostat. Authorization to access the thermostat is provided if the user obtaining the passcode from the display on the thermostat then enters it into a pairing dialog presented when the user logs into their thermostat management account. Pairing server 606 pairs the thermostat with the user's thermostat management account if the user enters that same passcode that was displayed on their thermostat display.

According to a preferred “auto-pairing” method, the pairing server 606 may automatically pair or “auto-pair” a thermostat management account to a thermostat if both are located on the same private network. If the thermostat and thermostat management account are associated with the same private network, embodiments of the present invention presume the thermostat is at the user's home, office, or other area where the user should also have control of the device. To make this determination automatically, the pairing server 606 compares the public network address that was used to register the thermostat over the Internet with the public network address used by the computer device that has most recently been used to access the thermostat management account. Since the thermostat and computer device only have private network addresses, the router on the private network they share inserts the same public network address into their packets thus allowing the two devices to access servers, services, and other devices on the Internet. “Auto-pairing” takes advantage of this fact and automatically pairs devices sharing the same public network address. This is particularly advantageous from a user standpoint in that the user is not bothered with the need to enter a passcode or other alphanumerical identifier in order to achieve the pairing process, and avoids the concern that a user may inadvertently enter incorrect codes or identifiers into the system. Details on auto-pairing and manually assisted pairing are described in further detail later herein.

Thermostat front end user-interface (UI) server 608 facilitates the generation and presentation of intuitive, user-friendly graphical user-interfaces that allow users to remotely access, configure, interact with, and control one or more of their network-connected thermostats 110/112 from a computer web browser, smartphone, tablet, or other computing device. The user-friendly graphical user-interfaces can also provide useful tools and interfaces that do not necessarily require real-time connectivity with the thermostats 110/112 with examples including, for some embodiments, providing user interfaces for displaying historical energy usage, historical sensor readings and/or occupancy patterns, allowing the user to learn about and/or enroll in demand-response programs, provide social networking forums that allow users to interact with each other in informative, competitive, fun ways that promote energy savings, provide access to local information including weather, public safety information, neighborhood calendar events, and local blogs, and more generally provide services and information associated with a comprehensive “energy portal” functionality. Examples of intuitive, user-friendly graphical user-interfaces provided by the UI server 608 according to one or more preferred embodiments are described further in co-pending U.S. patent application Ser. No. 13/317,423.

In some embodiments, a thermostat access client user-interface displays an image of a house representing a primary enclosure paired to the thermostat management account in the thermostat management system. Thermostat front end UI server 608 may further instruct the thermostat access client, such as thermostat access client 516 in FIG. 5, to display images visually representative of one or more thermostats 110/112 inside the primary enclosure. By default, each of the one or more thermostat images may also display a current temperature measurement in the enclosure. In some embodiments, the user-interface may also further display an image of an additional house, or houses, representing a secondary enclosure having additional thermostats that are also paired to the thermostat management account. The image of the additional house may appear smaller, out of focus or generally deemphasized visually in relationship to the image of the house representing the primary enclosure. Additional enclosures beyond the secondary enclosure can also be displayed in the user interface and should also appear visually deemphasized compared with the image displayed for the primary enclosure. Further information on the thermostat access client and user-interface are described in more detail in co-pending U.S. patent application Ser. No. 13/317,423.

Thermostat backend server 610 manages the storage of data used by various thermostat management servers in the thermostat management system 506. In some embodiments, thermostat backend server 610 may manage storage of the thermostat registration pool data used by the registration server 602 or may organize and store new software updates and releases for the update server 604. In another embodiment, thermostat backend server 610 may also store heating and cooling related data (i.e., date and time HVAC system was in either heating or cooling mode within the enclosure), sensor information, battery-level data, alarms, etc. associated with an enclosure that was sent to the thermostat management system 506 by thermostats registered therewith, and in some embodiments and provide pre-computed heating and cooling schedules, applications, and other data for download over the public network for use by the thermostats.

In some embodiments, thermostat management account server 612 is used to create new accounts and update existing accounts on thermostat management system 506. To access their thermostat over a thermostat access client 516 and enjoy the benefits of thermostat connectedness, the user is first required to create of a thermostat management account (“user account”) on thermostat management account server 612 using their thermostat access client 516. Accordingly, users execute the thermostat access client 516 on a computer or other computer device to access the thermostat management account server 612. The thermostat management account server 612 should receive at least the zip code and/or city and state for the enclosure in which the thermostat is (or will be) installed, such that weather information provided by a weather service can be accessed and downloaded to the thermostat, which can be used as part of its optimal enclosure characterization and HVAC control algorithms. Optionally, a variety of other information including a user's contact information, enclosure street addresses, and so forth can also be received. Primary options associated with the thermostat management account server 612 include pairing one or more thermostats to the correct thermostat management account through pairing operations provided by pairing server 606. However, even if the account is not yet paired with a thermostat, the user may use the thermostat management account to access local information including weather, public safety information, neighborhood calendar events, local blogs and more information based upon the user's contact information, locale and other interests.

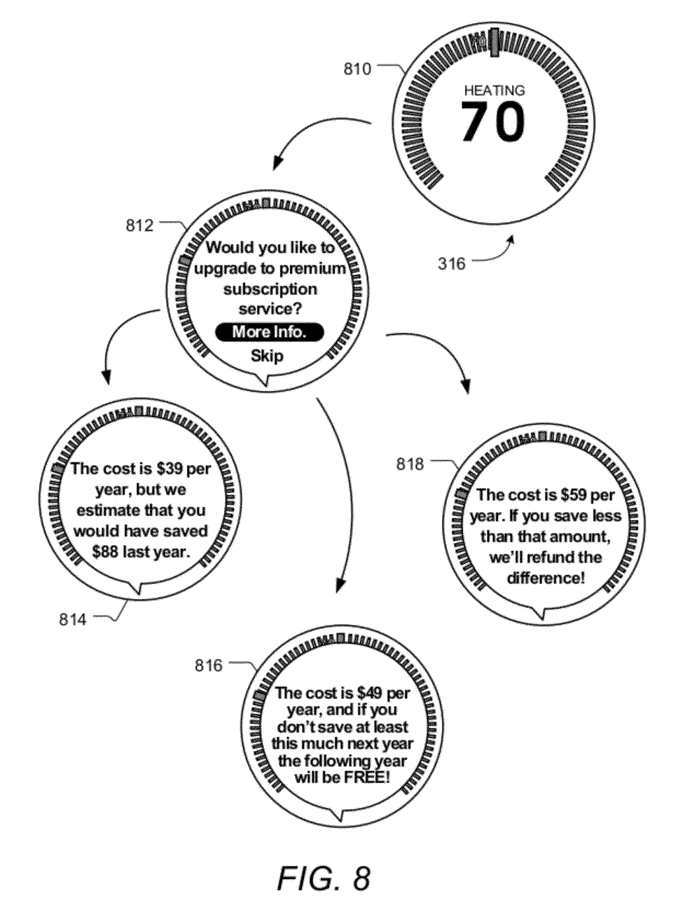

FIG. 7 is a flow chart showing steps in a combined business and technical method in which users are offered a subscription service by thermostat management server 506, according to some embodiments. Associated directly or indirectly with the thermostat management server 506 are automated computer programs, expert HVAC analysis personnel, and/or combinations thereof that are capable of developing new or improved computer algorithms that, when downloaded and installed onto one or more of the network connected multi-sensing thermostat units 110/112, can improve performance with respect to one or more criteria such as, but not limited to, energy efficiency, improved human comfort, new or improved interaction with remote devices or programs, new or improved conformance with government or utility standards, new or improved interactivity with other devices in a home energy network, new or improved compliance or interactivity with demand response programs, or any of a variety of other performance criteria or objectives. The information used in developing the new or improved computer algorithms can be based upon actual information associated with each particular installation (e.g., that customer's home and HVAC parameters, the sensing and operating logs of that customer's thermostat, etc.), can be based upon broader control principles that are generically applicable across all thermostat installations or groups of thermostat installations, or can be based on some combination of customer-specific and more generic control principles. According to one embodiment, the thermostat management server is configured and programmed to communicate with each customer of a network-connected multi-sensing learning thermostat such that each customer is offered a premium paid subscription to external control/optimization features. The thermostat customers who have chosen to pay for the premium subscription service are provided with at least one additional feature, capability, and/or option that is not provided to unpaid “basic” subscribers of a cloud-based thermostat servicing system that is provided for all thermostat owners. In step 710 a determination is made whether or not the thermostat user is a basic or premium subscribed user. If the user is already a premium subscriber, then in step 712 they are not longer presented with subscription offers until a renewal deadline is approaching. The premium user is offered one or more premium features that may not yet have been adopted such as described herein infra.

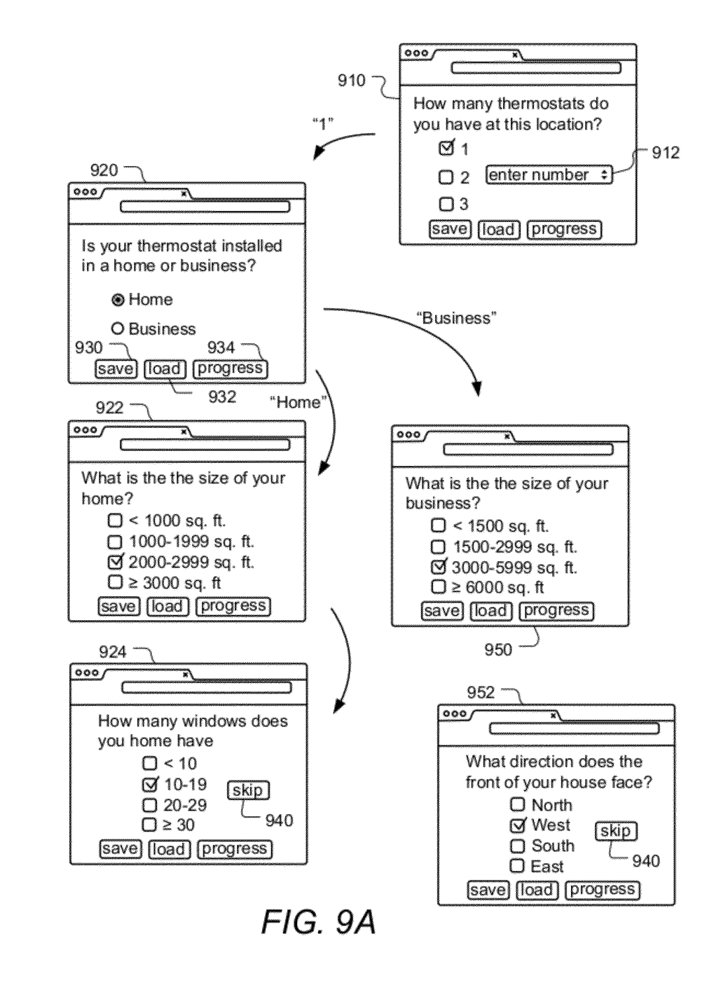

According to one embodiment, if a customer is a “basic” subscriber, the thermostat management server 506 will, behind the scenes with respect to the customer, simulate the operation of a new or improved computer algorithm for that customer's particular installation, in order to come up with an estimated cost savings that could be enjoyed by the customer if they adopted the improved computer algorithm. Thus, in step 714, the thermostat management server 506 runs an improved “premium” algorithm based on the historical internal and external temperature data for that customer. In step 716, the user is offered the premium subscription for example, using the display 316 of thermostat 110, shown in FIG. 8, infra, or a thermostat access client 516, shown in FIG. 5, supra. The offer can include the estimated cost savings calculated in step 714. According to some embodiments, in addition to or alternatively, in step 718 basic subscribers are encouraged to upgrade to a premium subscription by virtue of a money-back guarantee or no-net-cost guarantee that their savings in energy cost will at least cover their subscription cost, which is followed through upon by automated monitoring of their HVAC energy usage and before-and-after comparison. If they did not save enough money, the difference between the subscription cost and actual their energy savings will be reimbursed. According to some embodiments, the offers of steps 716 and/or 718 are made using an email sent to registered thermostat users who are have not yet upgraded to a premium subscription service.

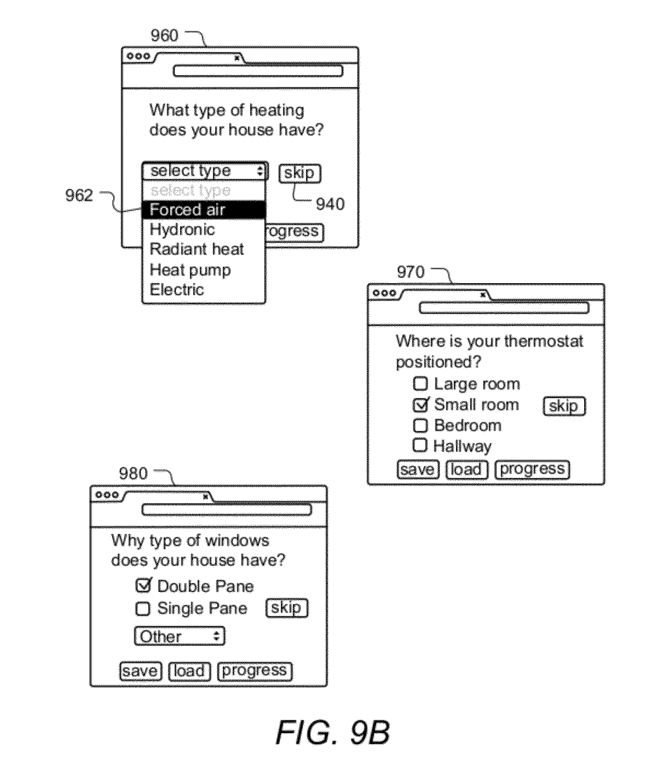

In step 720, if the user has accepted the offer for premium service, then control passes to step 724 and the according to some embodiments an on-line interactive customization tool (OICT) is activated which gathers information using an on-line interactive interview 730 as described in further detail in FIGS. 9A and 9B, infra. In step 732, a active thermodynamic test is performed on the user's enclosure. In step 734, based on the interview responses from step 730 and on the active test in step 732, a real-time thermal mass determination is made. According to some embodiments, a real-time thermodynamic model is generated and/or updated, as described further in co-pending U.S. patent application Ser. No. 12/881,463.

In step 740, the premium subscribers are offered access to a personal “energy coach” who can put together a highly customized algorithm for their thermostat based on question and answer sessions (by phone or e-mail), and optionally even based on a visit to the home. According to embodiments this service is charged at an additional rate or may have some portions included in the subscription price.

In step 742, for some embodiments, one particular aspect of the “premium” service will be directed toward subscribers having multiple thermostats governing multiple HVAC systems and/or multiple zones of a single HVAC system, with algorithms specially designed to coordinate their operation in an optimized manner. For example, where a customer has multiple thermostats for their home of business, an additional algorithm may be implemented to make sure the HVAC systems are operated out of phase with each other in regard to their cycling intervals, so as to increase thermodynamic performance by reducing undesirable cycling of the systems. According to some embodiments, in step 744, the premium subscription services also includes (or allows for an additional fee) a utility rate optimizer for use by customers who may have a choice of several utility providers, who often charge different rates during different times of the day. For example, the premium utility rate optimizer monitors energy usage, and either optimizes the selection of provider automatically, or makes recommendations to the user for further costs savings. According to some embodiments, the premium subscription service allows for better or improved graphics on the thermostat display and/or the access client, and/or also can reduce or eliminate advertising messages displayed on the access client.

FIG. 8 is a flow diagram illustrating aspects of a graphical user interface on a network-connected, multi-sensing learning thermostat adapted to offer premium subscription services, according to some embodiments. Screen 810 shows a display 316 of a thermostat 110 (shown in FIG. 3A). In screen 812, the user is offered a premium subscription. As shown in FIG. 7, supra, the thermostat management service runs one or more improved premium algorithms on the historical internal and external temperature data for the thermostat user. If the user selects “More info.” using the thermostat user interface, then according to some embodiments screen 814 is displayed. The screen displays the cost of the premium subscription (in this case $39 per year), and also displays the estimated cost savings. According to another example, not shown, the display 316 could include a more specific message such as, “The premium subscription service includes thermostat software version 2.0 which we estimate could have saved you $63 last year.” According to another example, screen 816 could be displayed which offers a type of money-back guarantee, in that the following year's subscription is free if the user's cost savings do not equal or exceed the $49 subscription. According to another example, screen 818 could be displayed which offers a form of no-net-cost guarantee in that the difference is refunded if the energy cost savings are less than the subscription price.

FIGS. 9A and 9B show aspects of a graphical user interface and an enhanced interview as part of a premium subscription service, according to some embodiments. According to some embodiments, premium subscribers are provided access to an online interactive customization tool (OICT) that allows them to specify data with greatly increased specificity about their home over what is provided by the standard startup interview, such as: (1) what direction their home faces, (2) square footage, (3) thermostat position information, (4) type of furnace/AC system, and (5) type of windows, etc. Based on this information an other available information (e.g. from public sources such as real estate databases, weather and climate information, etc., a custom set of algorithms for those particular options is downloaded to the user's thermostat. The OICT is preferably accessed by the user using the computer browser, tablet computer, smartphone, or other device that is also running their thermostat access client 516, although the scope of the present teachings is not so limited. By way of example, in alternative embodiments the OICT can adapted for implementation on the graphical user interface of the network connected, multi-sensing thermostats 110/112 themselves.

According to some embodiments, concepts from computer assisted interviewing (CAI) and in particular computer-assisted web interviewing (CAWI) are employed in designing the OICT such that the relatively complex questionnaire is more understandable for the thermostat user that is being interviewed. According to some embodiments, the OICT interview to contains pictures, audio and video clips, links to different web pages, etc. The OICT employs “smart branching” or customizing the flow of the questionnaire based on the answers provided, as well as information already known about the participant. Questions can be displayed with one or more of the following: check boxes, pull down menus, pop up menus, help screens, and sub menus. According to some embodiments, the questionnaire begins with a short introduction that informs the subject why the questionnaire is being conducted. Questions for questionnaire are created in the most appropriate type of format that facilitates understanding. Smart branching is utilized where appropriate to lessen complexity. For example, if a subject selects “yes” to a question, the questionnaire would automatically jump to the next relevant question and vice versa. A brief “thank you” note is included at the end of the questionnaire. In general, there are various response formats that can be for OICT interview, depending on the form of the question and the type of information sought. Examples of different formats include: radio buttons, check boxes, dropdown menus, open ended questions, and rating scales.

It is to be appreciated that the examples shown in FIGS. 9A and 9B, which are set forth for purposes of describing an on-line interactive customization tool (OICT) such as described with respect to FIG. 7, infra, show a small exemplary subset of the OICT interview. In screen 910 the user is asked how may thermostats are installed in the enclosure being conditioned. The most common answers are shown, namely 1, 2 or 3 with check boxes. If the user has more than three thermostats, the dropdown menu 912 can be used. Screen 920 is reached when the user answers “1” to the question in screen 910. In screen 920, the user is asked whether the thermostat is a home or business. Notice that the question in screen 920 uses the singular “thermostat” since it is already known from the answer to screen 910 that the user only has one thermostat installed. The user make a selection (home or business) using the radio buttons. Also note that all the screens preferably have save button 930 for saving the user's answers so as to allow exiting the interview process without loosing any time or work, and a load button 932 so load previously saved answers. According to some embodiments, every answer is automatically saved and therefore no save button 930 is necessary. Also preferably included in every screen is a progress button 934 that allows the user to view where in the OICT interview process they are. According to some embodiments, the OICT interview process is designed such that the user can skip around, and go through the questions in a different order for convenience of the user.

In screens 922 and 950 the user is asked what size the enclosure is. In the case of screen 922, where the thermostat is installed in a home, various ranges are presented that correspond to expected common sizes according to user's prior answers. Likewise in screen 950, where the thermostat is installed in a business, different ranges of areas are presented. Also, if the user had answered more than one thermostat in screen 910, different ranges and/or different questions. For example, the question “what approximate percentage of your home does this thermostat control?” might be asked when there are two thermostats installed in single home. Thus, through such smart branching, the relatively complex OICT interview processes is simplified and customized for each user. In screen 924 the user is asked about the number of windows in the home. Note the skip button 940 that allows the user to advance past certain questions. Through the navigation process (e.g. using the progress button 934) or at certain points in the OICT interview process, the user may be asked if they wish to provide answers to some of the skipped questions. In screen 952, the user is asked what direction the front of the house faces. In screen 960, the user is asked what type of heating system the home has. The user uses the drop down menu 962 to select from a list. In screen 970, the user is asked about the location of the thermostat. In screen 980 the user is asked about the construction of the windows. Thus through the use of smart branching, navigation features, saving and loading of answers, and skipping, a relatively complex OICT interview process is made more manageable to the user while increasing the likelihood that the user provides useful information for use in the advanced thermostat algorithms and/or thermodynamic modeling.

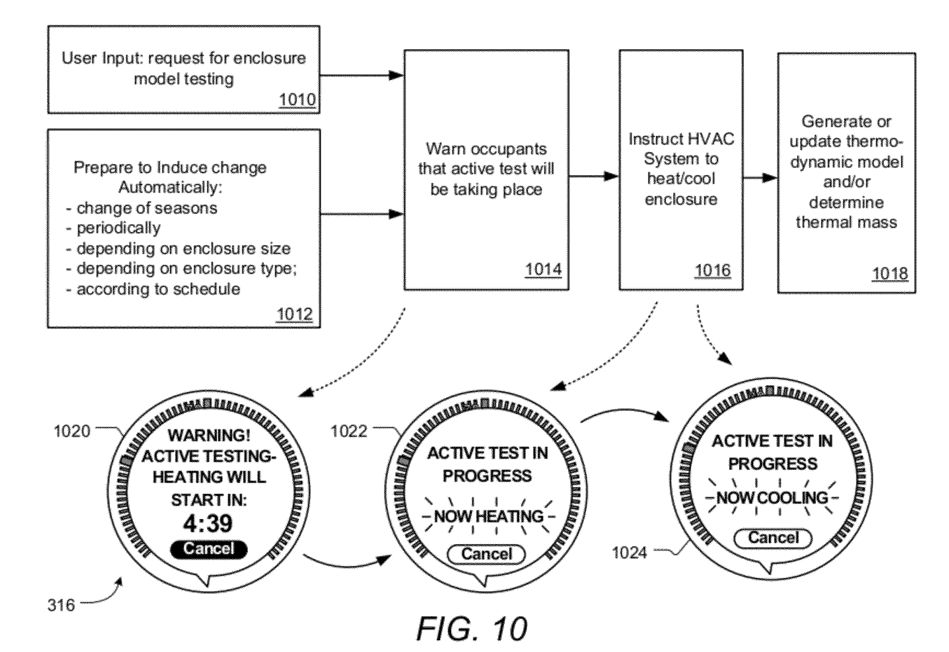

FIG. 10 is a flow chart showing aspects of a real-time thermal mass determination carried out as part of a premium subscription service, according to some embodiments. According to some embodiments, the thermostat will perform an active test by inducing a change such as by heating and/or cooling the enclosure. In step 1010 a user requests enclosure model testing, for example by requesting or agreeing to the active test via the thermostat user interface or the thermostat access client. The user, for example, might issue such a request after a substantial change in the structure, such as following remodeling work, replacing windows, adding insulation, etc. According to some embodiments, testing is performed autonomously, without a request being issued by a user. In step 1012, a decision is made to induce a change for testing purposed based on a number of factors. Factors that can be used include changing of seasons, after a fixed period of time (for example months or years), depending on the size of the enclosure, the type of enclosure (e.g. single family home, condominium/apartment, office, retail, etc.), and/or according to a predetermined schedule.

Since substantial heating and/or cooling of the structure is induced in the active testing, a warning is issued to the occupants in step 1016. The warning is preferably given both via the thermostat access client, and via the display 316 of the thermostat, an example of which is shown in screen 1020 in the case of heating. In screen 1020, the user is warned that the structure will be heated shortly using a count-down timer. The user is given the opportunity to cancel the active test by selecting “cancel” using the thermostat user interface or on the access client software interface. In step 1016, an active change is induced by the thermostat instructing the HVAC system to heat and/or cool the enclosure. In screens 1022 and 1024 the thermostat display 316 is used to display to occupants that heating and/or cooling is taking place as part of the active test. In step 1018, using the active heating and/or cooling of the enclosure, the processing system (either in the thermostat itself, the thermostat management service, or both), carries out calculations to generate a new thermodynamic model for the enclosure which may replace the currently used model, or may determine or update values of the thermal mass of the conditioned structure. For further details on thermodynamic modeling for enclosures, see co-pending U.S. patent application Ser. No. 12/881,463 and International Patent Application No. PCT/US11/51579, both of which are incorporated by reference herein. According to some embodiments the thermal mass determination based on the active test, is displayed real-time the customer using a browser window or smartphone via the thermostat access client 516 (shown in FIG. 5).

Various modifications may be made without departing from the spirit and scope of the invention. Accordingly, the invention is not limited to the above-described embodiments, but instead is defined by the appended claims in light of their full scope of equivalents.

What is claimed is:

1. A method for updating climate control settings in a network-connected thermostat, the method comprising:
using a processing system, offering a user of a network-connected thermostat a premium service which includes improved settings for the thermostat; and
updating the thermostat with the improved settings in the event that the user accepts the offer.

2. A method according to claim 1 further comprising, in the event that the user accepts the offer, activating online interactive customization that includes administering an on-line interview to gather information for use in the improved settings.

3. A method according to claim 2 wherein the on-line interview uses smart branching.

4. A method according to claim 2 wherein the information gathered using the on-line interview includes the approximate area of an enclosure or portion thereof that is conditioned using the thermostat.

5. A method according to claim 1 further comprising:
estimating, using a processing system, a value for cost savings associated with the user adopting the improved settings; and
displaying to the user the estimated value for the cost savings.

6. A method according to claim 1 further comprising estimating a value for cost savings associated with the user adopting the improved settings, wherein the offering the user includes offering a refunded amount in case an actual cost saving associated with the improved settings for the user are less than the cost of the subscription service.

7. A method according to claim 1 further comprising in the event that the user accepts the offer:
actively inducing a temperature change in an enclosure conditioned by an HVAC system under control of the thermostat, by heating or cooling the enclosure; and
calculating at least one thermodynamic parameter based at least in part on the induced temperature change, wherein the improved settings are based at least in part on the calculated thermodynamic parameter.

8. A method according to claim 7 wherein the at least on thermodynamic parameter includes a value for thermal mass of the conditioned enclosure.

9. A method according to claim 1 further comprising, in the event that the user accepts the offer, offering the user a personal energy coach.

10. A method according to claim 1 further comprising, in the event that the user accepts the offer, activating an automatic utility rate optimizer that decreases energy cost to the user by making a selection from a plurality of energy utility suppliers.

11. A method according to claim 1 wherein the improved settings include settings to facilitate or enhance interaction between the thermostat and one or more other thermostats installed in the same structure.

12. A method according to claim 1 wherein the improved settings include improved graphics used in a user interface associated with the thermostat.

13. A method according to claim 1 further comprising, in the event that the user accepts the offer, reducing an amount of advertising displayed to the user.

14. A system adapted and configured to update climate control settings in a network-connected thermostat according to the method of claim 1.

15. A method for updating climate control settings in a network-connected thermostat used to condition an enclosure using an HVAC system, the method comprising:
notifying a user of the network-connected thermostat that an active test will be performed on an enclosure;
actively inducing a change in the internal environment of the enclosure;
measuring a response of the internal environment of the enclosure at least in part due to the induced change; and
determining, with a processing system, at least one value for a thermodynamic parameter relating to the enclosure.

16. A method according to claim 15 wherein the notifying, inducing, measuring and determining are part of a premium service that the use has paid for.

17. A method according to claim 15 wherein the notifying includes displaying a notification on a display surface of the thermostat prior to actively inducing the change.

18. A method according to claim 15 wherein the notifying includes displaying a notification on a display surface of the thermostat during the inducing of the change.

19. A method according to claim 15 wherein the thermodynamic parameter is a thermal mass of the enclosure.

20. A method according to claim 15 wherein the thermodynamic parameter is used in a thermodynamic model for the enclosure that predicts thermal behavior of the enclosure.

21. A method according to claim 15 wherein the actively induced change in the internal environment includes actively inducing a change in temperature, and the measuring includes measuring the temperature of the internal environment of the enclosure.

22. A system adapted and configured to update climate control settings in a network-connected thermostat according to the method of claim 15.

23. A method for updating climate control settings in a network-connected thermostat, the method comprising:
using a processing system, estimating a value for cost savings associated with the a user of a network-connected thermostat adopting improved settings for the thermostat;
offering the user a premium service which includes the improved settings for the thermostat; and
updating the thermostat with the improved settings in the event that the user accepts the offer.

24. A method according to claim 23 further comprising displaying an offer to the user that includes the estimated value for the cost savings.

25. A method according to claim 23 further comprising offering the user refunded amount in case the user's actual cost saving associated with the improved settings are less than the cost of the subscription service.

26. A method according to claim 23 further comprising offering the user a discount of future service in case the user's actual cost saving associated with the improved settings are less than the cost of the subscription service.

27. A method according to claim 23 wherein the offering includes a guarantee that the cost of the premium service will at least be offset by energy cost savings.

28. A method according to claim 23 further comprising, in the event that the user accepts the offer, activating online interactive customization that include administering a on-line interview to gather information for use in the improved settings.

29. A method according to claim 23 further comprising in the event that the user accepts the offer:
actively inducing a temperature change in an enclosure conditioned by an HVAC system under control of the thermostat, by heating or cooling the enclosure; and
calculating at least one thermodynamic parameter based at least in part on the induced temperature change, wherein the improved settings are based at least in part on the calculated thermodynamic parameter.

30. A system adapted and configured to update climate control settings in a network-connected thermostat according to the method of claim 23.
